(19) United States
(12) Patent Application Publication
(10) Pub. No.: US 2011/0215747 A1
(43) Pub. Date: Sep. 8, 2011

(54) ELECTRIC ACTUATOR AND MODULE FOR SUPPLYING POWER DURING A POWER FAILURE

(75) Inventors: Makoto Saruwatari, Tokyo (JP); Hiroaki Narita, Tokyo (JP)

(73) Assignee: Yamatake Corporation, Tokyo (JP)

(21) Appl. No.: 12/968,464

(22) Filed: Dec. 15, 2010

(30) Foreign Application Priority Data
Mar. 5, 2010 (JP) 2010-048767
Mar. 5, 2010 (JP) 2010-048773
Mar. 5, 2010 (JP) 2010-048775
Mar. 5, 2010 (JP) 2010-048777

(51) Int. Cl. H02P 1/18

(52) U.S. Cl. 318/453

(57) ABSTRACT

An electric actuator is provided having the same configuration whether used as an ordinary electric actuator or as an electric actuator having an emergency shutoff function. A relay connector is provided in an electric actuator. When a module for supplying power during a power failure is connected, a first drive output signal generated by a motor drive circuit is relayed to the module and a motor power switching circuit is provided in the module. When the AC power supply does not fail, the first drive output signal sent from the electric actuator is selected; when the AC power supply fails, the second drive output signal generated by the motor drive circuit is selected and is sent to the AC motor of the electric actuator, via the relay connector.

### CROSS-REFERENCE TO RELATED APPLICATIONS

This application is being filed concurrently with co-pending U.S. patent application Ser. No. ______ (attorney docket number 96859/10) and U.S. patent application Ser. No. ______ (attorney docket number 96859/11), the contents of which are fully incorporated herein by reference.

### FIELD OF THE INVENTION

The present invention relates to a system, method and apparatus in accordance with an electric actuator that controls a flow by adjusting the aperture of a control target, such as a valve, damper, etc. Moreover, the present invention also relates to system, method and apparatus in accordance with a module for supplying power during a power failure that is used to connect to the electrical actuator.

### BACKGROUND OF THE INVENTION

Conventionally, to adjust the aperture of a control target, an electric actuator is used in air-conditioning equipment, targeting the control of the damper, etc., that adjusts the volume of conditioned air supplied to an air-conditioned area, via valves and ducts provided in cold- and hot-water piping thereof.

This type of ordinary electric actuator controls operation by providing an AC motor as the drive motor within the electric actuator to supply AC power as the operating power supply, and by matching the actual aperture of the control target to the set aperture, in accordance with control instructions from the air-conditioning controller. In such an electric actuator operated by such an AC power supply, when the supplied AC power fails, the aperture-controlled control target remains at the operating aperture immediately before power failure, and the appropriate aperture control can no longer be performed.

Therefore, an electric actuator of the following type has also been proposed and already exists: when the AC power supplied to the electric actuator fails, it is forcibly operated to the predetermined aperture (e.g., fully closed), and until the AC power supply returns to the conductive state, the predetermined aperture thereof is maintained. Hereinafter, this type of electric actuator is called an electric actuator having an emergency shutoff function.

As of now, two specific types have been proposed as an electric actuator having an emergency shutoff function: one type is called the spring return-type, and the other type is called the secondary power supply drive-type.

(Spring Return-Type Electric Actuator)

In the spring return-type electric actuator, a return spring biased so as to maintain the fully closed state relative to the drive shaft of the electric actuator is mounted, and when AC power is supplied, the aperture of the control target is adjusted by driving the drive motor against the biasing force of this return spring; and when the power fails, the aperture of the control target is forcibly set to the predetermined aperture by the biasing force of the return spring. An example of a spring return-type electric actuator can be found in Japanese Unexamined Patent Publication No. 2002-174269

(Secondary Power Supply Drive-Type Electric Actuator)

On the other hand, in the secondary power supply drive-type electric actuator, the drive motor of the electric actuator is a DC motor; it is separately equipped with a secondary power supply (DC power supply) that comprises a secondary battery, an electric double-layer capacitor, etc.; when AC power is supplied, the aperture of the control target is adjusted by converting this AC power to DC and driving the DC motor; when the power fails, the secondary power supply becomes the operating power supply; and the DC motor is driven by the secondary power supply (DC power supply), thereby forcibly setting the aperture of the control target to the predetermined aperture. An example of the secondary power supply drive-type electric actuator can be found in Japanese Unexamined Patent Publication No. 2008-89109.

However, when these two types of electric actuators having an emergency shutoff function are compared, in a normal state of the spring return-type electric actuator, the biasing force of the return spring functions as a resistance to the motor drive. Therefore, to overcome this resistance, a high-torque motor must be used as the drive motor, which has the disadvantage of increasing the size, weight, and cost of the electric actuator.

In contrast, the secondary power supply drive-type electric actuator lacks the disadvantages of the spring-return type, and is becoming advantageous because of, among other things, recent improvement in the capacitance of the electric double-layer capacitor and the secondary battery, which is the secondary power supply.

In the conventional electric actuator, however, there is considerable structural difference between an electric actuator having an emergency shutoff function and an electric actuator lacking an emergency shutoff function (the ordinary electric actuator), so manufacturers must produce two types of electric actuators.

In addition, when a user who has been using the ordinary electric actuator wants later to have the emergency shutoff function in the electric actuator, it is necessary either to considerably remodel the existing electric actuator or to separately purchase an electric actuator having an emergency shutoff function and substitute it for the existing electric actuator, which entails cost or time-consuming remodeling and substitution.

When the ordinary electric actuator is remodeled into a secondary power supply drive-type electric actuator, for example, an AC motor is used as the motor that drives the ordinary electric actuator, so it becomes necessary to substitute a DC motor for this AC motor, replace the control board, add a module having an emergency shutoff function, etc. It also is necessary to dispose of the replaced parts. Thus, when an ordinary electric actuator is remodeled into a secondary power supply drive-type electric actuator, the cost and time required for remodeling become excessive.

### SUMMARY OF THE INVENTION

The present invention was developed to solve the above problems, and it aims at providing an electric actuator that is capable of being used as both the ordinary electric actuator and as an electric actuator having an emergency shutoff function, while maintaining the same configuration. Furthermore, the present invention was developed to solve such problems by providing a module for supplying power during a power failure, that is capable of using the electric actuator having the same configuration that is capable of being used as both the ordinary electric actuator and as an electric actuator having an emergency shutoff function, while maintaining the same configuration.

To attain such an objective, in a module for supplying power during a power failure that is detachably connected via a cable to an electric actuator that comprises an AC motor, an actual aperture detection means that detects the actual aperture of a control target driven by the AC motor, a control means that generates a control output that matches to the set aperture the actual aperture detected by the actual aperture detection means, a first drive output signal generation means that receives the control output generated by the control means and generates a first drive output signal as the drive output signal to the AC motor, and an AC power supply input portion that is the energy source of the first drive output signal generated by the first drive output signal generation means, and that is capable of detachably connecting, via a cable, a module for supplying power during a power failure, which is equipped with a function that generates, as the second drive output signal, a drive output signal that causes the control target to reach a predetermined aperture, and a function that detects failure of the AC power supplied to the input portion, the present invention comprises a relay means that relays to the AC motor the first drive output signal when module for supplying power during a power failure is not connected, that relays to the module for supplying power during a power failure the first drive output signal when the module for supplying power during a power failure is connected, and that relays to the AC motor either the first drive output signal, which is selected when there is no failure of the AC power supply, or the second drive output signal, which is selected when there is failure of the AC power supply, in the module for supplying power during a power failure.

The present invention comprises an AC power supply relay means that relays AC power to the electric actuator, a power failure detection means that detects failure of the AC power to the electric actuator, a second drive output signal generation means that generates as the second drive output signal the drive output signal that adjusts the control target to the predetermine aperture, a means of supplying power during a power failure that acts as the energy source of the second drive output signal generated by the second drive output signal generation means, and a drive output signal selection means that selects the first drive output signal as the drive output signal to the AC motor when the power failure detection means does not detect failure of the AC power, and selects the second drive output signal as the drive output signal to the AC motor when the power failure detection means detects failure of the AC power, with the following inputs: the electric actuator-sent first drive output signal generated by the first drive output signal means and the second drive output signal generated by the second drive output signal generation means.

In the electric actuator of the present invention, when the module for supplying power during a power failure is not connected, the first drive output signal generated within the electric actuator is relayed to the AC motor, and control is performed to match the actual aperture of the control target to the set aperture. In other words, when the present invention's module for supplying power during a power failure is not connected to the electric actuator, the control performed within the electric actuator is such that the first drive output signal generated within the electric actuator is sent to the AC motor, and the actual aperture of the control target is matched to the set aperture. As a result, when the module for supplying power during a power failure is not connected, the electric actuator of the present invention functions as an ordinary electric actuator.

In the electric actuator of the present invention, when the module for supplying power during a power failure is connected to the electric actuator, the first drive output signal generated within the electric actuator is sent to the module for supplying power during a power failure. In this case, in the module for supplying power during a power failure, when there is no power failure in the AC power supply (e.g., if failure of the AC power supplied to the electric actuator is not detected), the first drive output signal (the drive output signal generated within the electric actuator) is selected as the drive output signal. During a power failure in the AC power supply (e.g., if failure of the AC power to the electric actuator is detected), the second drive output signal (the drive output signal generated within the module for supplying power during a power failure) is selected as the drive output signal. This selected drive output signal is relayed to the AC motor of the electric actuator.

As a result of this relay, in the electric actuator of the present invention, when the first drive output signal (the drive output signal generated within the electric actuator) is sent (e.g., when a power failure does not occur/when there is no power failure in the AC power supply), control is performed to set the actual aperture of the control target to the set aperture. After the second drive output signal has been sent (when the AC power supply fails), control is performed to match the actual aperture of the control target to the predetermined aperture (e.g., fully closed). As a result, when the module for supplying power during a power failure is connected, the electric actuator of the present invention functions as an electric actuator having an emergency shutoff function.

When the electric actuator is used in combination with the module for supplying power during a power failure, when a power failure does not occur, the first drive output signal (the drive output signal generated within the electric actuator) selected by the module for supplying power during a power failure is sent to the AC motor, and control is performed to match the actual aperture of the control target to the set aperture. When a power failure occurs, the second drive output signal (the drive output signal generated within the module for supplying power during a power failure) selected by the module for supplying power during a power failure is sent to the AC motor, and control is performed so as to cause the actual aperture of the control target to reach the set aperture (e.g., fully closed). As a result, this electric actuator functions as an electric actuator having an emergency shutoff function.

According to the electric actuator of the present invention, when the module for supplying power during a power failure is not connected, it functions as an ordinary electric actuator; when the module for supplying power during a power failure is connected, it functions as an electric actuator having an emergency shutoff function; and depending on whether or not the module for supplying power during a power failure is connected, an electric actuator having the same configuration can be used either as an ordinary electric actuator or an electric actuator having an emergency shutoff function. Moreover, according to the module for supplying power during a power failure of the present invention, when the electric actuator is not connected, this electric actuator can be made to function as an ordinary electric actuator; when the electric actuator is connected, this electric actuator can be made to function as an electric actuator having an emergency shutoff function; and depending on whether or not the module for supplying power during a power failure is connected, an electric actuator having the same configuration can be used either as an ordinary electric actuator or an electric actuator having an emergency shutoff function.

In exemplary embodiments, the systems and methods can include an electric actuator comprising a motor, the motor being responsive to a first signal generated internal to the electric actuator when primary power is being supplied to the electric actuator and to a second signal generated external to the electric actuator when primary power is removed from the electric actuator. The first signal may be capable of being provided external to the electric actuator. Further, the first signal may be provided external to the electric actuator and may be returned to the electric actuator. Additionally, the shutoff function may enable the motor to operate when primary power is removed from the electric actuator.

In exemplary embodiments, the systems and methods can include an electric actuator comprising a motor responsive, in a first mode, to a first signal generated internal to the electric actuator and, in a second mode, to a second signal generated external to the electric actuator. The electric actuator can be configured to provide the first signal external to the electric actuator. Further, the electric actuator can be configured to receive the first signal in the first mode. Still further, the electric actuator can be configured to receive the second signal in the second mode. The first mode can occur when primary power is removed from the electric actuator. The second mode can occur when primary power is no longer being supplied to the electric actuator.

In exemplary embodiments, the systems and methods can further include an electric actuator including a rotatable shaft responsive to the motor and a device coupled to the shaft for detecting its rotational position. The electric actuator can generate a position signal indicating the rotational position of the shaft. Further, the device can be configured to provide the position signal external to the electric actuator. Still further, the device may additionally comprise a potentiometer. Additionally, the device can generate an arrival signal indicating that the shaft has arrived at a predetermined position. The electric actuator may be configured to provide the arrival signal external to the electric actuator. The device may further comprise a limit switch.

In exemplary embodiments, the systems and methods can include a module capable of being detachably connected to an electric actuator for providing the electric actuator with a shutoff function without reconfiguration of the electric actuator.

In exemplary embodiments, the systems and methods can include a module comprising a detection circuit for generating a power failure detection signal indicating whether primary power is being supplied to the module. Further, the module can comprise a switching circuit for outputting either a first signal generated external to the module or a second signal generated internal to the module based on the state of the power failure detection signal. The module may be configured to provide the output of the switching circuit external to the electric actuator. The module may further comprise a power supply circuit disposed within the module and a circuit for generating the second signal, which is coupled to the power supply circuit. The circuit may discontinue generating the second signal in response to a signal generated external to the module. Further, the circuit may discontinue generating the second signal in response to a signal generated internal to the module. Still further, the power supply circuit may store power when primary power is applied to the module.

In exemplary embodiments, the systems and methods can include an electric actuator system including an electric actuator and a module detachably connected to the electric actuator to provide the electric actuator with a shutoff function.

In exemplary embodiments, the systems and methods can include an electric actuator system comprising an electric actuator and a module detachably connected to the electric actuator. The electric actuator can comprise a motor being responsive, in a first mode, to a first signal generated by the electric actuator and, in a second mode, to a second signal generated by the module. The first signal can be provided to the module and is returned to the electric actuator from the module in the first mode. The second signal can be provided to the electric actuator by the module in the second mode. The module may comprise a switching circuit for receiving the first signal and the second signal and outputting to the electric actuator the first signal in the first mode and the second signal in the second mode. The first mode may occur when primary power is being supplied to the electric actuator. The second mode may occur when primary power is removed from the electric actuator.

In exemplary embodiments, the systems and methods can include an electric actuator system further comprising a rotatable shaft responsive to the motor and a device coupled to the shaft for detecting its rotational position. The device may generate a position signal indicating the position of the shaft. Further, the electric actuator may provide the position signal to the module. Additionally, the device may generate an arrival signal indicating that the shaft has arrived at a predetermined position. The electric actuator may also provide the arrival signal to the module. Still further, the module may discontinue generating the second signal in response to the arrival signal.

In exemplary embodiments, the method can comprise the steps of generating a first signal internal to the electric actuator; generating a second signal external to the electric actuator; detecting whether primary power is being supplied to the electric actuator; providing the first signal to the electric actuator when the detecting step indicates that primary power is being supplied to the electric actuator; and providing the second signal to the electric actuator when the detecting step indicates that primary power is removed from the electric actuator. The electric actuator may comprise a rotatable shaft and the method may further comprise the steps of detecting the rotational position of the shaft and generating a third signal that indicates the position of the shaft. Further, the method may comprise the step of comparing the position of the shaft to a predetermined position. Additionally, the step of generating the second signal may cease to be performed if the comparing step indicates that the shaft has reached the predetermined position. When the electric actuator comprises a rotatable shaft, the method may further comprise the step of determining when the shaft has reached a predetermined position. The step of generating the second signal may cease if the determining step indicates that the shaft has reached the predetermined position.

In exemplary embodiments, the systems and methods can include an electric actuator that comprises an AC motor, an actual aperture detection means that detects the actual aperture of a control target driven by the AC motor, a control means that generates a control output that matches to the set aperture the actual aperture detected by the actual aperture detection means, a first drive output signal generation means that receives the control output generated by the control means and generates a first drive output signal as the drive output signal to the AC motor, and an AC power supply input portion that is the energy source of the first drive output signal generated by the first drive output signal generation means; and that is capable of detachably connecting, via a cable, a module for supplying power during a power failure, which is equipped with a function that generates, as the second drive output signal, a drive output signal that causes the control target to reach a predetermined aperture, and a function that detects failure of the AC power supplied to the input portion. The electric actuator can comprise a relay means that relays to the AC motor the first drive output signal when module for supplying power during a power failure is not connected, that relays to the module for supplying power during a power failure the first drive output signal when the module for supplying power during a power failure is connected, and that relays to the AC motor either the first drive output signal, which is selected when there is no failure of the AC power supply, or the second drive output signal, which is selected when there is failure of the AC power supply, in the module for supplying power during a power failure.

In exemplary embodiments, the systems and methods can include a module for supplying power during a power failure that is detachably connected via a cable to an electric actuator that comprises an AC motor, an actual aperture detection means that detects the actual aperture of a control target driven by the AC motor, a control means that generates a control output that matches to the set aperture the actual aperture detected by the actual aperture detection means, a first drive output signal generation means that receives the control output generated by the control means and generates a first drive output signal as the drive output signal to the AC motor, and an AC power supply input portion that is the energy source of the first drive output signal generated by the first drive output signal generation means. The module for supplying power during a power failure may comprise an AC power supply relay means that relays AC power to the electric actuator, a power failure detection means that detects failure of the AC power to the electric actuator, a second drive output signal generation means that generates as the second drive output signal the drive output signal that adjusts the control target to the predetermine aperture, a means of supplying power during a power failure that acts as the energy source of the second drive output signal generated by the second drive output signal generation means, and a drive output signal selection means that selects the first drive output signal as the drive output signal to the AC motor when the power failure detection means does not detect failure of the AC power, and selects the second drive output signal as the drive output signal to the AC motor when the power failure detection means detects failure of the AC power, with the following inputs: the electric actuator-sent first drive output signal generated by the first drive output signal means and second drive output signal generated by the second drive output signal generation means.

In exemplary embodiments, the systems and methods can include a module for supplying power during a power failure which may output a DC power supply as the power supplied during a power failure. The module can further include a second drive output signal generation means for generating a second drive output signal, with the power supplied during a power failure, which is outputted by the means of supplying power during a power failure, as the AC-converted output.

In exemplary embodiments, the systems and methods can include a means of supplying power during a power failure further including an AC/DC power supply conversion means that converts to DC power the branching input, with the AC power supply relayed by AC power supply relay means as the branching input. Additionally, the means of supplying power may include a storage means that stores the charge obtained from the DC power supply converted by the AC/DC power supply conversion means. Still further, the means of supplying power may include a DC power supply voltage adjustment means that generates the DC powers supply whose voltage was adjusted by the charge stored in the storage means, and outputs it as the power supplied during a power failure. The second drive output signal generation means may generate a second drive output signal based on notification notified by the electric actuator as to whether or not the control target has reached the predetermined aperture. Additionally, the module for supplying power during a power failure additionally may comprise a predetermined aperture arrival determination means that determines whether or not the control target has arrived at the predetermined aperture, based on the actual aperture of the control target, which is provided by the electric actuator. The second drive output signal generation means may generate the second drive output signal, based on the result of the determination as to whether or not the control target has reached the predetermined aperture, as determined by the predetermined aperture arrival determination means.

### BRIEF DESCRIPTION OF THE DRAWINGS

Exemplary embodiments of this invention will be described with reference to the accompanying figures.

FIG. 1 is a block diagram showing the main portion of a first embodiment of the electric actuator, before connection of the module for supplying power during a power failure of the present invention.

FIG. 2 is a diagram showing the appearance of this electric actuator.

FIG. 3 is a diagram showing the state in which the first embodiment of the module for supplying power during a power failure of the present invention is connected to this electric actuator.

FIG. 4 is a block diagram of the main portion when the module for supplying power during a power failure is connected to this electric actuator.

FIG. 5 is a diagram showing the configuration of the interior of the module for supplying power during a power failure.

FIG. 6 is a diagram showing a second embodiment in which the actual aperture detection signal is sent from the electric actuator to the module for supplying power during a power failure.

Next, embodiments of the electric actuator and module for supplying power during a power failure of the present invention will be described in detail, based on the drawings.

### DETAILED DESCRIPTION OF THE EXEMPLARY EMBODIMENTS

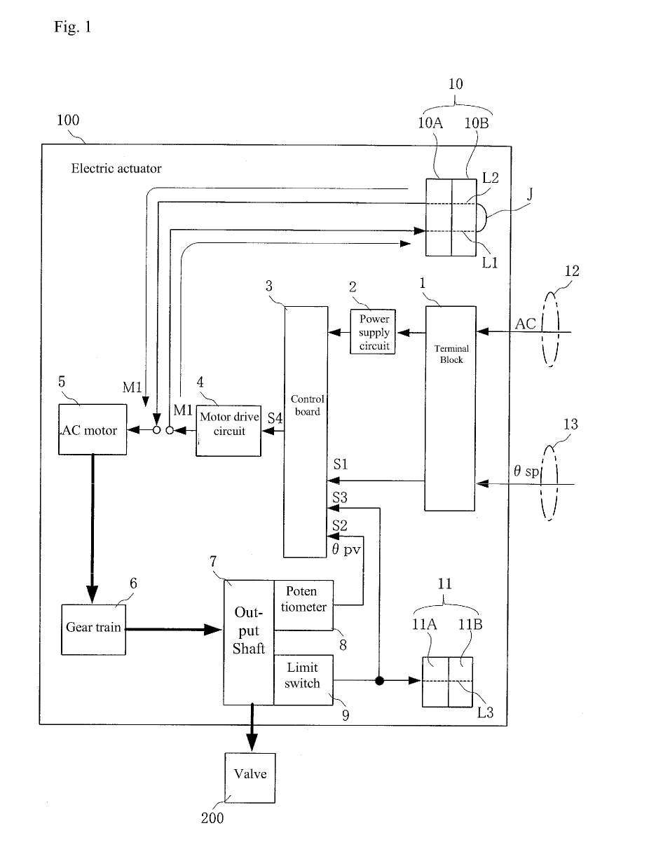

FIG. 1 is a block diagram showing the main portion of a first embodiment of the electric actuator before connection of the module for supplying power during a power failure of the present invention. In the figure, 100 is an electric actuator of the present invention, and 200 is a valve (control target) whose aperture is controlled by this electric actuator 100.

The electric actuator 100 comprises a terminal block 1, a power supply circuit 2, a control board 3, a motor drive circuit 4, an AC motor 5, a gear train 6 that transmits the driving force of the AC motor 5, an output shaft 7 that adjusts the aperture of the valve 200 as the output terminal of this gear train 6, a potentiometer 8 that detects the rotation angle position of this output shaft 7 as the actual aperture θ pv of the valve 200, a limit switch 9 that detects the arrival at a predetermined rotation angle position of the output shaft 7 as the arrival at a predetermined aperture of the valve 200 (in this example, arrival at the fully closed position of the valve 200), and relay connectors 10 and 11.

In this electric actuator 100, the AC power supply is inputted at the terminal block 1 as the operating power supply from the exterior, and this AC power supply becomes the required internal power supply in the power supply circuit 2, after which it is supplied to the control board 3. In addition, in the terminal block 1, the set aperture θ sp is inputted as a control instruction from an air-conditioning controller (not shown), and this inputted set aperture θ sp is sent to the control board 3 as a set aperture signal S1. Also, in the control board 3, the valve 200's actual aperture θ pv from the potentiometer 8 is provided as an actual aperture detection signal S2, and the signal from the limit switch 9, which indicates arrival at the valve 200's predetermined aperture, is provided as a predetermined aperture arrival signal S3.

The control board 3 receives the set aperture signal S1 from the air-conditioning controller and the actual aperture detection signal S2 from the potentiometer 8, generates a control output S4 that matches the actual aperture θ pv of the valve 200 to the set aperture θ sp, and sends this generated control output S4 to the motor drive circuit 4. The motor drive circuit 4 receives the control output S4 from the control board 3, and generates a drive output signal M1 (first drive output) to the AC motor 5.

The relay connector 10, which is provided between the motor drive circuit 4 and the AC motor 5, relays to the AC motor 5 the first drive output signal M1 from the motor drive circuit 4. In this example, the relay connector 10 has a partitioned configuration consisting of a male-side connector 10A and a female-side connector 10B. By connecting a jumper wire J between the connector paths L1, L2 at the female-side connector 10B, the first drive output signal M1 from the motor drive circuit 4 is sent to the AC motor 5, via the relay connector 10.

The relay connector 11 has a partitioned configuration consisting of a male-side connector 11A and a female-side connector 11B. By only connecting the female-side connector 11B to the male-side connector 11A, the predetermined aperture arrival signal S3 from the limit switch 9 is terminated at the connector path L3 thereof.

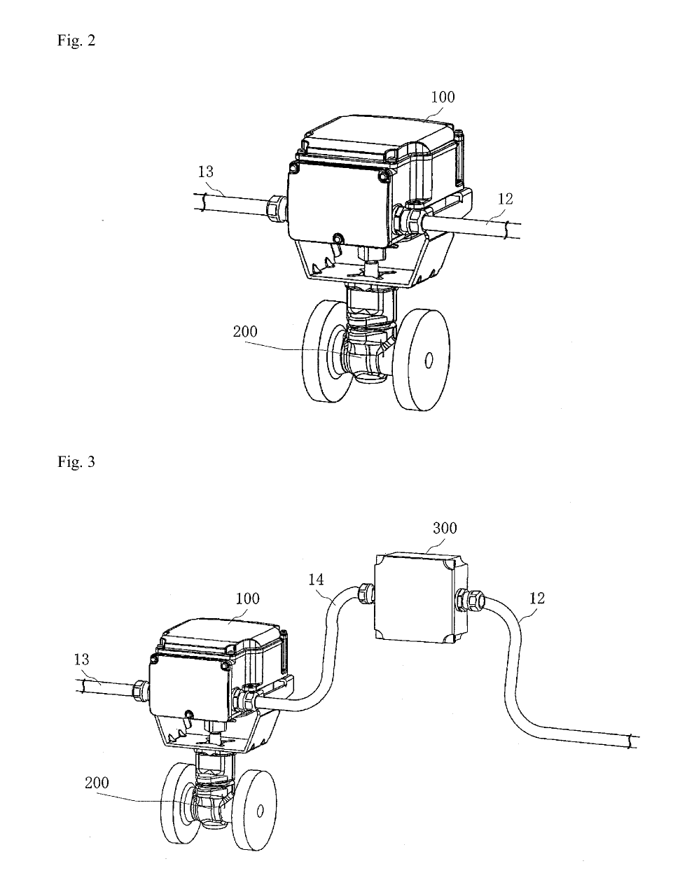

FIG. 2 is a diagram showing the appearance of this electric actuator 100. In the figure, power line 12 leads the AC power supply into the interior of the electric actuator 100, and signal line 13 is the signal line that leads the set aperture θ sp into the interior of the electric actuator 100.

In this electric actuator 100, by sending the first drive output signal M1 generated by the motor drive circuit 4 to the AC motor 5 via the relay connector 10 (connector paths L1, L2), control is performed so as to match the actual aperture θ pv of the valve 200 to the set aperture θ sp. In this manner, this electric actuator 100 functions as an ordinary electric actuator.

(When it is Used as an Electric Actuator Having an Emergency Shutoff Function)

As shown in FIG. 3, when it is desired to use this electric actuator 100 as an electric actuator having an emergency shutoff function, a module 300 for supplying power during a power failure is connected between the electric actuator 100 and the power line 12, via a cable 14.

That is, the power line 12 is detached from the electric actuator 100, this power line 12 is connected to the input side of the module 300, and the cable 14 is used to connect the output side of the module 300 and the input side of the electric actuator 100.

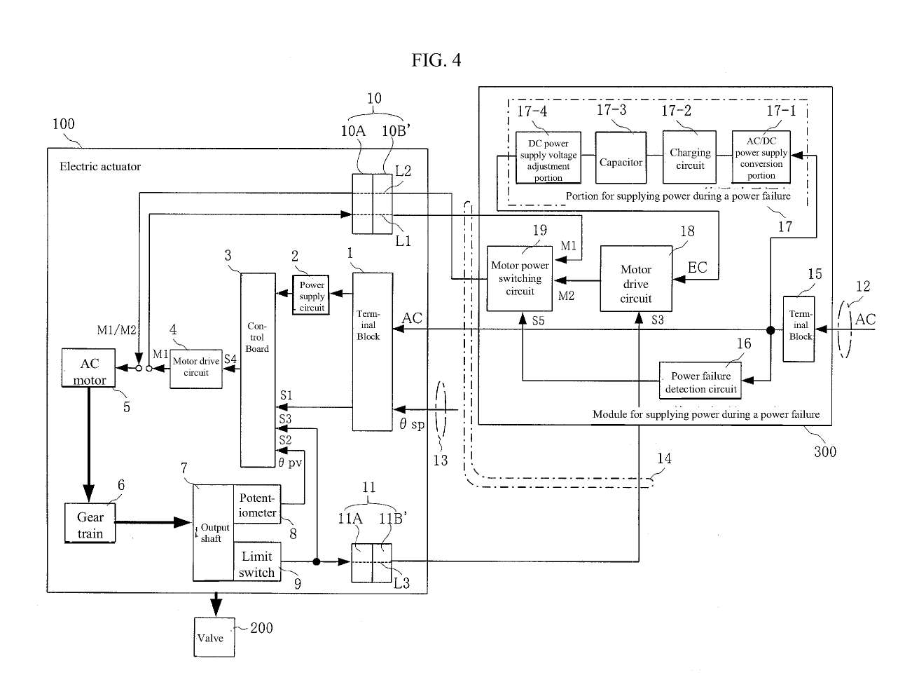

FIG. 4 is a block diagram of the main portion when the module 300 is connected to the electric actuator 100. The module 300 is one embodiment of the power failure module of the present invention, and it comprises a terminal block 15, a power failure detection circuit 16, a portion for supplying power during a power failure 17, a motor drive circuit 18, and a motor power switching circuit 19.

When this module 300 is connected to the electric actuator 100, the female-side connector 10B (FIG. 1) of the relay connector 10 is detached in the electric actuator 100, and the female-side connector 10B′ led out from the motor power switching circuit 19 of the module 300 is connected to the male-side connector 10A.

Moreover, the female-side connector 11B (FIG. 1) of the relay connector 11 is detached, and the female-side connector 11B′ led out from the motor drive circuit 18 of the module 300 is connected to the male-side connector 11A.

Also, in the module 300, the power line 12 is connected to the terminal block 15, and the AC power supply relayed by this terminal block 15 is sent to the terminal block 1 of the electric actuator 100, via the interior of the module 300.

In this case, the cable 14 that connects the module 300 and the electric actuator 100 comprises the female-side connector 10B′-derived line from the motor power switching circuit 19, the female-side connector 11B′-derived line from the motor drive circuit 18, and the relay line of the AC power supply relayed by the terminal block 15.

Furthermore, in this example, the configuration is such that, when the module 300 is connected to the electric actuator 100, the female-side connector 10B and the female-side connector 11B are detached. However, similar wiring is obtainable by using the female-side connector 10B and the female-side connector 11B.

In the module 300, the power failure detection circuit 16 monitors the AC power supply relayed by the terminal block 15, and outputs the power failure detection yes/no signal S5, which notifies of the presence/absence of a power failure in the AC power supply supplied to the electric actuator 100.

The portion 17 for supplying power during a power failure comprises an AC/DC power supply conversion portion 17-1 that converts to DC power the branching input, with the AC power supply relayed by the terminal block 15 as the branching input; a charging circuit 17-2 that operates after receiving the DC power supply converted by the AC/DC power supply conversion portion 17-1; a capacitor (electric double-layer capacitor or lithium ion capacitor) 17-3 charged by the charging circuit 17-2; and a DC power supply voltage adjustment portion 17-4 that generates DC power whose voltage is adjusted (e.g., increased, decreased, or is unchanged) using the charge stored in the capacitor 17-3 and outputs that DC power as the secondary power EC that is used during a power failure.

The motor drive circuit 18 generates a drive output signal M2 (second drive output) to the AC motor 5, based on the predetermined aperture arrival signal S3 sent via the relay connector 11 (connector path L3) in the electric actuator 100, with the secondary power, which is outputted from the portion 17 for supplying power during a power failure, as the energy source. In this case, the motor drive circuit 18 generates the second drive output signal M2 until confirmation of the generation of the predetermined aperture arrival signal S3, with the secondary power EC (voltage-adjusted DC power supply) from the portion 17 as the AC-converted output.

By using as inputs the first drive output signal M1, which is sent via the relay connector 10 (connector path L1) and is generated by the motor drive circuit 4 in the electric actuator 100, and the second drive output signal M2, which is generated by the motor drive circuit 18 in the module 300, and based on the power failure detection yes/no signal S5 from the power failure detection circuit 16, the motor power switching circuit 19 selects that first drive output signal M1 as the drive output to the AC motor 5 if the power failure detection circuit 16 does not detect failure of the AC power supply, and selects the second drive output signal M2 as the drive output to the AC motor 5 if the power failure detection circuit 16 detects failure of the AC power supply. The selected drive output from the motor power switching circuit 19 is sent to the AC motor 5 in the electric actuator 100 via the relay connector 10 (connector path L2).

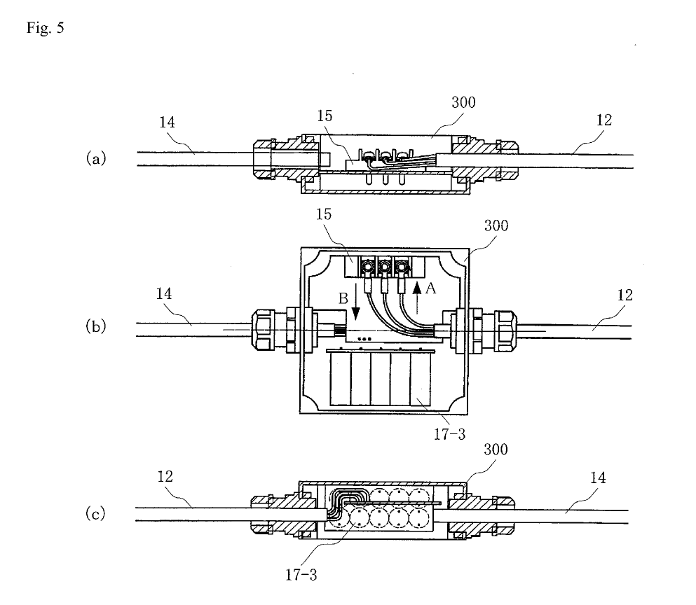

FIG. 5 shows the configuration of the interior of the module 300. FIG. 5(b) is a diagram showing the interior (after opening the cover) of the module 300. FIG. 5(a) is a diagram of the terminal block 15 side in FIG. 5(b), as viewed in direction A. FIG. 5(c) is a diagram of the capacitor 17-3 side in FIG. 5(b), as viewed in direction B. A plurality of capacitors (electric double-layer capacitors, lithium ion capacitors) 17-3 are provided in the module 300 to ensure high-capacity secondary power EC during power failure.

(When the Power does not Fail)

When the AC power supply to the electric actuator 100 does not fail, the motor power switching circuit 19 in the module 300 selects, as the drive output to the AC motor 5, the drive output signal M1 (the first drive output signal M1 generated by the motor drive circuit 4) sent from the electric actuator 100 via the relay connector 10 (connector path L1), based on the power failure detection yes/no signal S5 from the power failure detection circuit 16.

This selected first drive output signal M1 from the motor power switching circuit 19 is sent to the AC motor 5 in the electric actuator 100, via the relay connector 10 (connector path L2). As a result, control is such that, when the AC power supply to the electric actuator 100 does not fail, the actual aperture θ pv of the valve 200 is matched to the set aperture θ sp, by the first drive output signal M1, which is generated with the AC power supply as the energy source.

(When the Power Fails)

When the AC power supply to the electric actuator 100 fails, the motor power switching circuit 19 in the module 300 selects, as the drive output to the AC motor 5, the drive output signal M2 (the second drive output signal M2 generated by the motor drive circuit 18), which is generated in the module 300, based on the power failure detection yes/no signal S5 from the power failure detection circuit 16.

This selected second drive output signal M2 from the motor power switching circuit 19 is sent to the AC motor 5 in the electric actuator 100, via the relay connector 100 (connector path L2). As a result, when the AC power supply to the electric actuator 100 fails, the second drive output signal M2, whose energy source is the secondary power EC (i.e., during power failure), controls in such a manner that the actual aperture θ pv of the valve 200 is set to the predetermined aperture (in this case, the fully closed state). In this case, when the actual aperture θ pv of the valve 200 arrives at the predetermined aperture and the predetermined aperture arrival signal S3 is inputted into the motor drive circuit 18, the motor drive circuit 18 discontinues output of the second drive output signal M2.

(When Power is Restored)

In the module 300, monitoring of the AC power supply in the power failure detection circuit 16 continues even after the AC power supply fails. When AC power supply is restored, the power failure detection circuit 16 notifies the motor power switching circuit 19 of the fact, by using the power failure detection yes/no signal S5.

After being notified by the power failure detection circuit 16 of the fact that AC power supply has been restored, the motor power switching circuit 19 selects, as the drive output to the AC motor 5, the drive output signal M1 (the first drive output signal M1 generated by the motor drive circuit 4), which is sent from the electric actuator 100, via the relay connector 10 (connector path L1).

This selected first drive output signal M1 from the motor power switching circuit 19 is sent to the AC motor 5 in the electric actuator 100, via the relay connector 10 (connector path L2). As a result, when AC power supply is restored, control is such that the first drive output signal M1, which is generated with the AC power supply as the energy source, matches the actual aperture θ pv of the valve 200 to the set aperture θ sp, as before the power failure.

Thus, when the module 300 is connected to the electric actuator 100, the electric actuator 100, which had until then functioned as an ordinary actuator, begins to function as an electric actuator having an emergency shutoff function.

In this electric actuator 100, the terminal block 1 corresponds to the input portion of the AC power supply of the present invention; the control board 3 corresponds to the control means; the motor drive circuit 4 corresponds to the first drive output generation means; the AC motor 5 corresponds to the AC motor; the potentiometer 8 corresponds to the actual aperture detection means; and the relay connector 10 corresponds to the relay means. In addition, in the module 300, the terminal block 15 corresponds to the AC power supply relay means of the present invention; the power failure detection circuit 16 corresponds to the power failure detection means; the portion 17 for supplying power during a power failure corresponds to the means of supplying power during a power failure; the motor drive circuit 18 corresponds to the second drive output generation means; and the motor power switching circuit 19 corresponds to the drive output selection means.

As aforementioned, according to the electric actuator 100 of the present embodiment, when the module 300 is not connected, it causes the electric actuator 100 to function as an ordinary electric actuator; and when the module 300 is connected to the electric actuator 100, it causes the electric actuator 100 to function as an electric actuator having an emergency shutoff function.

In this case, the power line 12 and the cable 13 must be connected, but the electric actuator 100 need not be remodeled; and by either connecting or not connecting the module 300, it is possible to use an electric actuator 100 having the same configuration either as an ordinary electric actuator or as an electric actuator having an emergency shutoff function.

As a result, manufacturers need not produce two types of electric actuators. In addition, it becomes possible to simply change on site from an ordinary electric actuator to an electric actuator having an emergency shutoff function.

Also, in this example, the electric actuator 100 becomes the secondary power supply drive type.

Therefore, it becomes unnecessary to increase drive motor capacity and strengthen gears for the amount of absent biasing force of the return spring, compared with the spring return type. In addition, the existing wiring layout need not be changed, so the power line 12 and the signal line 13 can be used as they are. Moreover, the module 300 can be positioned at an arbitrary position, so it becomes possible to change the electric actuator 100 to an electric actuator having an emergency shutoff function, even in a confined space.

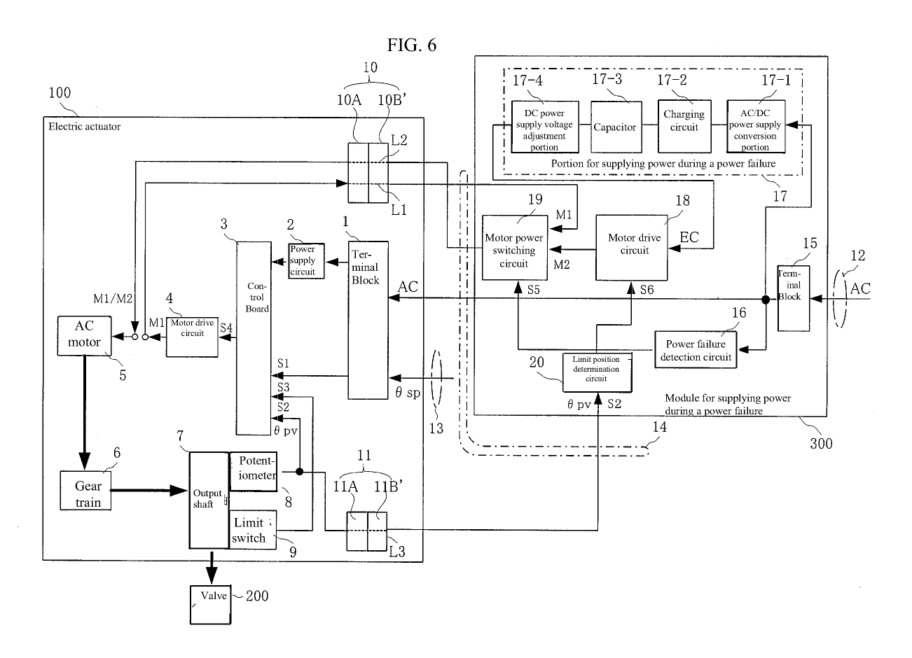

In the first embodiment described above, the configuration is such that, when the module 300 is connected to the electric actuator 100, the predetermined aperture arrival signal S3 is sent from the electric actuator 100 to the module 300. However, the actual aperture detection signal S2 may be sent instead of the predetermined aperture arrival signal S3. FIG. 6 shows an example wherein the actual aperture detection signal S2 is sent from the electric actuator 100 to the module 300, as a second embodiment.

In this second embodiment, the actual aperture detection signal S2 is sent from the electric actuator 100 to the module 300, via the relay connector 11 (connector path L3). The limit position determination circuit 20 is provided in the module 300, and based on the actual aperture θ pv, sent from the electric actuator 100 as the actual aperture detection signal S2, it is determined whether or not the valve 200 has reached the predetermined aperture (in this case, the fully closed state). The result of this determination is sent to the motor drive circuit 18, as the limit position determination signal S6, instead of the predetermined aperture arrival signal S3. Therefore, it is possible to arbitrarily determine the set aperture during a power failure.

Furthermore, in the aforementioned example, the configuration is such that there is a partitioned configuration in which the relay connector 10 is partitioned into the male-side connector 10A and the female-side connector 10B, and a jumper wire J is connected between these connector paths L1, L2, in the female-side connector 10B. However, when the motor drive circuit 4 and the AC motor 5 are directly connected via a connector and the module 300 is connected, the wiring shown in FIG. 4 may be implemented by detaching the connector linking the motor drive circuit 4 and the AC motor 5, connecting a separately provided wiring member between these connectors, etc. In this case, the means that includes the connector connecting the motor drive circuit 4 and the AC motor 5 and the wiring member connected between these connectors corresponds to the relay means of the present invention.

Furthermore, in the aforementioned example, the portion 17 for supplying power during a power failure in the module 300 is configured by using a capacitor (electric double-layer capacitor, lithium ion capacitor). However, a lithium battery or other secondary battery may also be used, and a primary battery may also be used. Thus, various devices such as a non-rechargeable battery (e.g., primary battery), a rechargeable battery (e.g., secondary battery), electric double-layer capacitor, etc., can be used as the means of generating the secondary power EC, and they may be used by selecting appropriately.

### INDUSTRIAL APPLICABILITY

The electric actuator and module of the present invention may be used in various fields, such as air-conditioning equipment, as the module is connected to an electric actuator that controls a flow by adjusting the aperture of a control target, such as a valve, damper, etc.

### DESCRIPTION OF THE SYMBOLS

1 Terminal block, 2 Power supply circuit, 3 Control board, 4 Motor drive circuit, 5 AC motor, 6 Gear train, 7 Output shaft, 8 Potentiometer, 9 Limit switch, 10, 11 Relay connector, 10A, 11A Male-side connector, 10B, 10B′, 11B, 11B′ Female-side connector, L1, L2, L3 Connector path, J Jumper wire, 12 Power line, 13 Signal line, 14 Cable, 15 Terminal block, 16 Power failure detection circuit, 17 Portion for supplying power during a power failure, 17-1 AC/DC power supply conversion portion, 17-2 Charging circuit, 17-3 Capacitor (e.g., electric double-layer capacitor, lithium ion capacitor), 17-4 DC power supply voltage adjustment portion, 18 Motor drive circuit, 19 Motor power switching circuit, 20 Limit position determination circuit, 100 Electric actuator, 200 Valve, 300 Module for supplying power during a power failure,

Now that embodiments of the present invention have been shown and described in detail, various modifications and improvements thereon will become readily apparent to those skilled in the art. Accordingly, the exemplary embodiments of the invention, as set forth above, are intended to be illustrative, not limiting. The spirit and scope of the present invention is to be construed broadly and limited only by the appended claims, and not by the foregoing specification.

What is claimed is:

1. An electric actuator comprising a motor, the motor being responsive to a first signal generated internal to the electric actuator when primary power is being supplied to the electric actuator and to a second signal generated external to the electric actuator when primary power is removed from the electric actuator.

2. The electric actuator of claim 1, wherein the first signal is further capable of being provided external to the electric actuator.

3. The electric actuator of claim 1, wherein the first signal is further provided external to the electric actuator and is returned to the electric actuator.

4. An electric actuator, comprising a motor responsive, in a first mode, to a first signal generated internal to the electric actuator and, in a second mode, to a second signal generated external to the electric actuator.

5. The electric actuator of claim 4, wherein the electric actuator is configured to further provide the first signal external to the electric actuator.

6. The electric actuator of claim 5, wherein the electric actuator is configured to receive the first signal in the first mode.

7. The electric actuator of claim 4, wherein the electric actuator is configured to receive the second signal in the second mode.

8. The electric actuator of claim 4, wherein the first mode occurs when primary power is removed from the electric actuator.

9. The electric actuator of claim 8, wherein the second mode occurs when primary power is no longer being supplied to the electric actuator.

10. The electric actuator of claim 4, further comprising:
a rotatable shaft responsive to the motor; and
a device coupled to the shaft for detecting its rotational position.

11. The electric actuator of claim 10, wherein the device generates a position signal indicating the rotational position of the shaft.

12. The electric actuator of claim 11, wherein the electric actuator is configured to provide the position signal external to the electric actuator.

13. The electric actuator of claim 12, wherein the device comprises a potentiometer.

14. The electric actuator of claim 12, wherein the device generates an arrival signal indicating that the shaft has arrived at a predetermined position.

15. The electric actuator of claim 14, wherein the electric actuator is configured to provide the arrival signal external to the electric actuator.

16. The electric actuator of claim 15, wherein the device comprises a limit switch.

17. A module capable of being detachably connected to an electric actuator to provide the electric actuator with a shutoff function without reconfiguration of the electric actuator.

18. The module of claim 17, further comprising:
a power supply circuit disposed within the module;
a detection circuit for generating a power failure detection signal indicating whether primary power is being supplied to the module; and
a circuit outputting either a first signal or a second signal based on a state of the power failure detection signal.

19. The module of claim 18, wherein the circuit discontinues outputting the second signal in response to a signal generated external to the module.

20. The module of claim 18, wherein the circuit discontinues outputting the second signal in response to a signal generated internal to the module.

21. The module of claim 18, wherein the power supply circuit stores power when primary power is applied to the module.

22. A module for supplying power to an electric actuator, comprising:
a detection circuit for generating a power failure detection signal indicating whether primary power is being supplied to the module; and
a switching circuit outputting either a first signal generated external to the module or a second signal generated internal to the module based on the state of the power failure detection signal.

23. The module of claim 22, wherein the module is configured to provide the output of the switching circuit external to the module.

24. The module of claim 23, further comprising:
a power supply circuit disposed within the module; and
a circuit for generating the second signal, the circuit coupled to the power supply circuit.

25. The module of claim 24, wherein the circuit discontinues generating the second signal in response to a signal generated external to the module.

26. The module of claim 24, wherein the circuit discontinues generating the second signal in response to a signal generated internal to the module.

27. The module of claim 24, wherein the power supply circuit stores power when primary power is applied to the module.

28. An electric actuator system, comprising:
an electric actuator; and
a module detachably connected to the electric actuator to provide the electric actuator with a shutoff function.

29. An electric actuator system, comprising:
an electric actuator; and
a module detachably connected to the electric actuator;
wherein:
the electric actuator comprises a motor, the motor being responsive, in a first mode, to a first signal generated by the electric actuator and, in a second mode, to a second signal generated by the module;
the first signal is provided to the module and is returned to the electric actuator from the module in the first mode; and
the second signal is provided to the electric actuator by the module in the second mode.

30. The electric actuator system of claim 29, wherein the module comprises a switching circuit receiving the first signal and the second signal and outputting to the electric actuator the first signal in the first mode and the second signal in the second mode.

31. The electric actuator system of claim 30, wherein the first mode occurs when primary power is being supplied to the electric actuator.

32. The electric actuator system of claim 31, wherein the second mode occurs when primary power is removed from the electric actuator.

33. The electric actuator system of claim 29, wherein the electric actuator further comprises:
a rotatable shaft responsive to the motor; and
a device coupled to the shaft for detecting its rotational position.

34. The electric actuator system of claim 33, wherein the device generates a position signal indicating the position of the shaft.

35. The electric actuator system of claim 34, wherein the electric actuator provides the position signal to the module.

36. The electric actuator system of claim 33, wherein the device generates an arrival signal indicating that the shaft has arrived at a predetermined position.

37. The electric actuator system of claim 36, wherein the electric actuator provides the arrival signal to the module.

38. The electric actuator system of claim 37, wherein the module discontinues generating the second signal in response to the arrival signal.

39. A method for providing an electric actuator with a shutoff function, the method comprising the steps of:
generating a first signal internal to the electric actuator;
generating a second signal external to the electric actuator;
detecting whether primary power is being supplied to the electric actuator;
providing the first signal to the electric actuator when the detecting step indicates that primary power is being supplied to the electric actuator; and
providing the second signal to the electric actuator when the detecting step indicates that primary power is removed from the electric actuator.

40. The method of claim 39, wherein the electric actuator comprises a rotatable shaft, the method further comprising the steps of:
detecting the rotational position of the shaft; and
generating a third signal that indicates the position of the shaft.

41. The method of claim 40, further comprising the step of comparing the position of the shaft to a predetermined position.

42. The method of claim 41, wherein the step of generating the second signal ceases to be performed if the comparing step indicates that the shaft has reached the predetermined position.

43. The method of claim 39, wherein the electric actuator comprises a rotatable shaft, and the method further comprises the step of determining when the shaft has reached a predetermined position.

44. The method of claim 43, wherein the step of generating the second signal ceases if the determining step indicates that the shaft has reached the predetermined position.
